(19) United States
(12) Patent Application Publication
(10) Pub. No.: US 2025/0153089 A1
(43) Pub. Date: May 15, 2025

(54) MODULAR TRUE MOVING BED APPARATUS FOR GAS SEPARATION AND METHOD OF SAME

(71) Applicant: Tata Consultancy Services Limited, Mumbai (IN)

(72) Inventors: Navneet Singh Badhan, Pune (IN); Ayush Chaudhary, Pune (IN); Sivakumar Subramanian, Pune (IN); Mohammed Suhail, Pune (IN); Venkataramana Runkana, Pune (IN); Davuluri Prahlada Rao, Hyderabad (IN)

(73) Assignee: Tata Consultancy Services Limited, Mumbai (IN)

(21) Appl. No.: 18/924,710

(22) Filed: Oct. 23, 2024

(30) Foreign Application Priority Data
Nov. 9, 2023 (IN) 202321076710

(51) Int. Cl. B01D 53/06

(52) U.S. Cl. CPC B01D 53/06

(57) ABSTRACT

This disclosure relates generally to modular true moving bed apparatus for gas separation and method of same. Traditional gas separation processes utilizing absorption techniques are energy intensive. The present disclosure provides gas separation process where a plurality of carriages carrying a sorbent material are in motion through a plurality of zones. Further, a gaseous mixture over the plurality of carriages carrying the sorbent material are fed via at least one inlet port of the adsorption zone. Then, a target gas is adsorbed from the gaseous mixture by the sorbent material while passing through the adsorption zone. The target gas from the sorbent material are desorbed inside each carriage in the desorption zone. Finally, using a suitable sealing mechanism, the inlet one-way valve and the outlet one-way valve of each carriage carrying the sorbent material are sealed during exit from at least one zone to prevent leakage with the adjoining zones.

### PRIORITY CLAIM

This U.S. patent application claims priority under 35 U.S.C. § 119 to: Indian Patent Application No. 202321076710, filed on Nov. 9, 2023. The entire contents of the aforementioned application are incorporated herein by reference.

### TECHNICAL FIELD

The disclosure herein generally relates to gas separation, and, more particularly, to modular true moving bed apparatus for gas separation and method of same.

### BACKGROUND

True moving bed (TMB) has acquired significative importance in industrial environments due to its ability to efficiently separate complex systems. Its applications range from petrochemical to fine chemical and pharmaceutical industries. True Moving Bed (TMB) improves selectivity towards a given product to integrate reaction and separation in the same unit while potentially reducing capital investment and energy consumption. TMB is also used for gas separation, allowing gas separation and purification by separating pure components from a mixture of components, a process which is of critical importance in the chemical industry.

Traditional gas separation processes utilize absorption technique to capture carbon dioxide from flue gas. Such absorption techniques are very energy intensive. On the other hand, adsorption technique that uses porous material to separate pure components from a gaseous mixture is more energy efficient process that can be used for gas separation and purification. Due to the existence of a variety of adsorbents that can selectively adsorb components of interest, adsorption finds applications in a variety of processes such as natural gas purification, air separation, carbon capture, and the like.

The use of true moving bed adsorption reactors for gas separation and purification encounters several challenges, including particle attrition as an inherent problem. However, existing reactors such as rotary bed has addressed the problem in which particles do not move relative to each other. The complexity of processes renders this reactor configuration impractical. Further, existing reactors also lack in maintaining continuity of operations as they shut down to replace depleted adsorbent bed with new sorbent bed, resulting in disruptive maintenance cycles.

### SUMMARY

Embodiments of the present disclosure present technological improvements as solutions to one or more of the above-mentioned technical problems recognized by the inventors in conventional systems. For example, in one embodiment, modular true moving bed apparatus for gas separation is provided. The apparatus includes a static gas-tight enclosure 102, a locomotion means 104, a plurality of carriages (106a,106b, . . . ,106n) capable of traversing via the locomotion means 104. Each of the plurality of carriages comprises a front end having an inlet one-way valve, and a rear end having an outlet one-way valve, and each of the plurality of carriages carries a sorbent material.

The locomotion means 104 provides a mechanism to adjust a distance between two consecutive carriages from among the plurality of carriages while in motion. Further, a plurality of zones comprising an adsorption zone 108 and a desorption zone 110, connected in series in a closed loop, wherein the plurality of carriages traverse through the plurality of zones, and each of the plurality of zones comprises at least one inlet port to feed a gaseous mixture and at least one outlet port to exit raffinate. Each of the plurality of carriages carrying the sorbent material traverses via the locomotion means through each zone during the gas separation process. The adsorption zone 108 receives a gaseous mixture from at least one of the inlet port, and each of the plurality of carriages (106a,106b, . . . ,106n) carrying the sorbent material adsorbs a target gas from the gaseous mixture while traversing via the locomotion means, the desorption zone 110 desorbs the target gas from the sorbent material present inside each of the plurality of carriages (106a,106b, . . . ,106n). Further, a sealing mechanism seals the inlet one-way valve and the outlet one-way valve of each of the plurality of carriages carrying the sorbent material to prevent leakage in the adjoining zones.

In another aspect, a modular true moving bed apparatus for gas separation is provided. The process includes a static gas-tight enclosure 102, a locomotion means 104, a plurality of carriages (106a,106b, . . . , 106n) capable of traversing via the locomotion means 104. Each of the plurality of carriages comprises a front end having an inlet one-way valve, and a rear end having an outlet one-way valve, and each of the plurality of carriages carries a sorbent material.

The locomotion means 104 provides a mechanism to adjust a distance between two consecutive carriages from among the plurality of carriages while in motion. Further, a plurality of zones comprising an adsorption zone 108 and a desorption zone 110, connected in series in a closed loop, wherein the plurality of carriages traverse through the plurality of zones, and each of the plurality of zones comprises at least one inlet port to feed a gaseous mixture and at least one outlet port to exit raffinate. Each of the plurality of carriages carrying the sorbent material traverses via the locomotion means through each zone during the gas separation process. The adsorption zone 108 receives a gaseous mixture from at least one of the inlet port, and each of the plurality of carriages (106a,106b, . . . ,106n) carrying the sorbent material adsorbs a target gas from the gaseous mixture while traversing via the locomotion means, the desorption zone 110 desorbs the target gas from the sorbent material present inside each of the plurality of carriages (106a,106b, . . . ,106n). Further, a sealing mechanism seals the inlet one-way valve and the outlet one-way valve of each of the plurality of carriages carrying the sorbent material to prevent leakage in the adjoining zones.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates a modular true moving bed apparatus for gas separation constructed in accordance with some embodiments of the present disclosure.

FIG. 2 illustrates a schematic process configuration of the modular true moving bed apparatus for gas separation using the system of FIG. 1, in accordance with some embodiments of the present disclosure.

FIG. 3 illustrates a schematic view of an adsorption zone for gas separation process using the system of FIG. 1, in accordance with some embodiments of the present disclosure.

FIG. 4 illustrates a schematic view of a desorption zone operating in pressure swing adsorption for gas separation process using the system of FIG. 1, in accordance with some embodiments of the present disclosure.

FIG. 5 illustrates a schematic view of a cooling zone and a maintenance zone for gas separation process using the system of FIG. 1, in accordance with some embodiments of the present disclosure.

FIG. 6A and FIG. 6B illustrates a top view and an isometric view of a plurality of carriages inside the adsorption zone and exiting the adsorption zone, with the front end and rear end one-way valve opened while inside the zone and closed while exiting the zone using the system of FIG. 1, in accordance with some embodiments of the present disclosure.

FIG. 6C and FIG. 6D illustrates a top view and an isometric view of the plurality of carriages inside the desorption zone and exiting the desorption zone, with the front end and rear end one-way valve opened using the system of FIG. 1, in accordance with some embodiments of the present disclosure.

FIG. 6E illustrates the carriage design for carrying the sorbent material through the plurality of zones via locomotion means using the system of FIG. 1, in accordance with some embodiments of the present disclosure.

FIG. 6F illustrates airtight casing around the apparatus with carriages moving on conveyor belt as a locomotion means using the system of FIG. 1, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following embodiments described herein.

In conventional true moving bed reactor for gas separation, the adsorbent material or sorbent particles move from top to bottom under the effect of gravity, going through each adsorption zone, desorption zone, and cooling zone, where the feed moves counter-currently from bottom to top. The adsorbent material is transferred from bottom to top using a bucket elevator or a screw conveyor. Such configuration results in decreased pressure drop and shorter column length because of stationary reaction front inside the column. Major disadvantage of conventional moving bed reactor is particle attrition of adsorbent particles, resulting in lower particle life and increased cost of the process. Additionally, steam is used to directly heat the particles for desorption, leading to an additional step of dehydration followed by the cooling step before the particles are lifted to the top for the next cycle. The condensed steam also reduces the capacity of the adsorbent. Moreover, as the beds are interconnected without a partition, pressure swing for regeneration cannot be employed.

In traditional rotating bed reactor, particles are fixed in a circular bed that rotates to move the adsorbent particles through different zones of the gas separation process. This configuration was designed to separate CO2 from industrial flue gas. Another existing technology allows use of structured adsorbents in an intensified temperature swing adsorption (i-TSA) process. Here, the gas separation efficiency of the process depends upon the efficiency of the sealing mechanism to prevent leakage between different sections that operate at different pressure. This sealing and leakage across different sections are actually a major problem when using such reactor configuration. As the feed gas and the outlet gas ports are located near the walls of the reactor, the flow through the beds may suffer from channeling, leaving some section of the bed underutilized and making the absorption less effective if the gases were to find shorter ways through the bed. The embodiments of the present disclosure address the problem of particle attrition in modular true moving bed apparatus gas separation, preventing gas leakage across different zones and adsorbent maintenance problems associated with the current technologies.

### Glossary

As used herein, “TMB” means “true moving bed.”

As used herein, “raffinate” is a product stream pumped from the TMB during operation that corresponds to the least retained component.

As used herein, “carriage” means a container which carries a sorbent material.

As used herein, “sorbent material” is an eluent which absorbs or desorbs the target gas, and which is carried inside the carriage through the locomotion means.

As used herein, “adsorption zone” refers to the section of the bed where adsorption of a target gas from a gaseous mixture occurs.

As used herein, “desorption zone” refers to the section of the bed where desorption of the target gas from the sorbent bed occurs.

As used herein, “locomotion means” is a type of mechanism enabling the carriage to move through the process zones.

As used herein, “static gas-tight enclosure” is an external outer jacket preventing gas leakage.

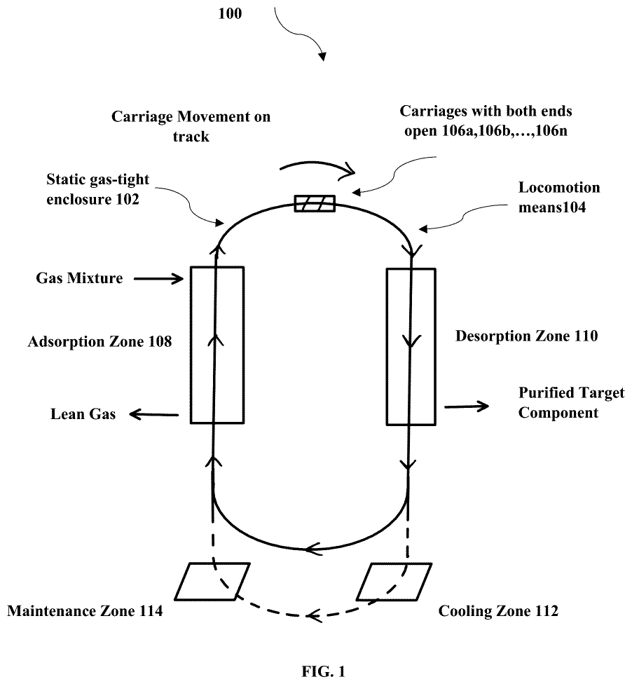

Embodiments herein provide a modular true moving bed apparatus for gas separation and method of same. The modular true moving bed apparatus may be alternatively referred to as apparatus or system. The apparatus 100 provides an efficient method for gas separation in which a sorbent material is carried in a plurality of carriages. The apparatus provides solution for challenges in existing techniques, proving minimal particle attrition since the sorbent particles inside the plurality of carriages have no relative motion among themselves during traversal through various zones. The disclosed system is further explained with the method as described in conjunction with FIG. 1 to FIG. 6F below.

Referring now to the drawings, and more particularly to FIG. 1 through FIG. 6F, where similar reference characters denote corresponding features consistently throughout the figures, there are shown preferred embodiments, and these embodiments are described in the context of the following exemplary system and/or method.

FIG. 1 illustrates a modular true moving bed apparatus for gas separation constructed in accordance with some embodiments of the present disclosure. The modular true moving bed apparatus for gas separation 100 comprises a static gas-tight enclosure 102, a locomotion means 104, a plurality of carriages (106a,106b, . . . ,106n), and a plurality of zones comprising an adsorption zone 108, a desorption zone 110, a cooling zone 112 and a maintenance zone 114.

The present disclosure contemplates towards gas separation using sorbent particles or structured sorbents, with no relative motion among themselves, carried in the plurality of carriages (106a,106b, . . . ,106n) capable of traversing via the locomotion means 104. Each of the adsorption zone 108, the desorption zone 110, the cooling zone 112 and the maintenance zone 114 are connected sequentially and the plurality of carriages (106a,106b, . . . ,106n) carrying the sorbent material move through each zone using the locomotion means 104.

The sorbent material may include for example structured sorbents called monoliths, or particulate adsorbents that are packed inside carriages with each carriage moving sequentially through each zone in the gas separation process. Each carriage is a packed moving bed with, but not limited to, circular cross-section to minimize mechanical and thermal stress and optimize the heat transfer characteristics of the process.

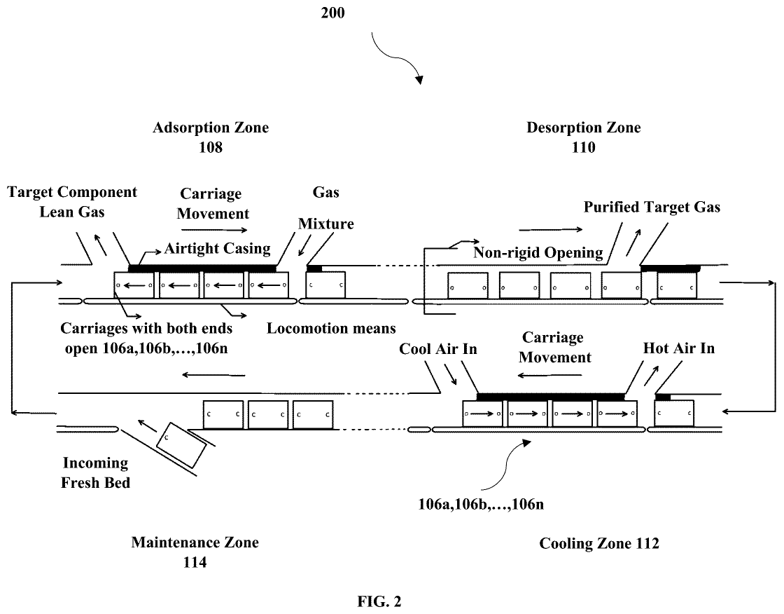

FIG. 2 illustrates a schematic process configuration of the modular true moving bed apparatus for gas separation using the system of FIG. 1, in accordance with some embodiments of the present disclosure. The apparatus 200 may be an example of the apparatus 100 (FIG. 1). In an example embodiment, the apparatus 200 may be embodied in, or is in direct communication with the apparatus, for example the apparatus 100 (FIG. 1). The apparatus 200 comprises of the static gas-tight enclosure 102, the locomotion means 104, the plurality of carriages (106a,106b, . . . ,106n), the adsorption zone 108, the desorption zone 110, the cooling zone 112 and the maintenance zone 114.

The static gas-tight enclosure 102 of the system 200 is an outer jacket preventing gas leakage to the external environment. The locomotion means 104 and the plurality of carriages (106a,106b, . . . ,106n) are enclosed with tight tolerances such that there is no gas leakage across sections. The one-way valve-like provision is used for opening and closing the ends of each carriage to prevent leakage of the target gas from each zone subsequently.

The locomotion means 104 provides a directional movement to move the plurality of carriages (106a,106b, . . . ,106n) from each zone towards subsequent zones. The locomotion means 104 may have a track working under a mechanical principle and in continuous motion. The locomotion means 104 may consist of a set of rollers that rotate to facilitate carriage motion or consist of rollers fixed to each carriage. The locomotion means 104 provides the mechanism to adjust distance between two consecutive carriages while traversing the plurality of zones of the gas separation process as less gap is required between carriages in the adsorption zone to prevent gas bypass. This facilitates sequential passage of the target gas through each carriage and relatively more gap is desirable in the desorption zone 110 operating in a vacuum swing adsorption (VSA) and/or pressure swing adsorption (PSA) facilitating evacuation of the target gas from each carriage.

The plurality of carriages (106a,106b, . . . ,106n) traverse via the locomotion means 104. Each carriage includes a front end having an inlet one-way valve and a rear having an outlet one-way valve, and each carriage carries the sorbent material. Here, the sorbent material remain fixed inside each carriage that moves via the locomotion means 104, traversing through each zone among the plurality of zones. Since the sorbent particles do not move relative to each other, there is no risk of particle attrition, and it is possible to have high performing structured adsorbents (monoliths) and standard adsorbents packing in the moving bed.

The sorbent material residing inside the plurality of carriages (106a,106b, . . . ,106n) have no relative motion among themselves, resulting in minimal particle attrition.

The plurality of zones comprises the adsorption zone 108, the desorption zone 110, which are connected in series in a closed loop. The plurality of carriages (106a,106b, . . . ,106n) traverse through the plurality of zones, where each zone comprises at least one inlet port and at least one outlet port to process feed gas within each zone, except for the desorption zone operating in VSA since only outlet port(s) is required to evacuate each carriage. For example, each of the zone, except desorption zone as explained above may have one or more inlet ports to allow for entry of the feed or recycled gas. Also, each zone may have one or more outlet ports to allow for the exit of the raffinate from each zone.

The plurality of carriages (106a,106b, . . . ,106n) carrying the sorbent material traverse via the locomotion means 104 through each zone during the gas separation process. Each carriage moves along the track but not limited to elliptical or circular via the locomotion means 104 that is used to speed up or slow down each carriage to maintain a suitable gap between them as required in different zones in the process based on factors such as adsorption time and desorption time.

The track of the locomotion means 104 may be equipped with, for example, conveyor belts, carriages with wheels with each carriage locomotion controlled independent of the other. Moreover, the track can be suitably inclined to increase or decrease the speed of each carriage decreasing the amount of energy required to move the plurality of carriages. The track geometry may be optimized to have long linear sections that are connected by acceptable curved sections depending on the desired layouts to a particular deployment environment.

The adsorption zone 108 receives a gaseous mixture through each inlet port, and each carriage carrying the sorbent material selectively adsorbs the target gas from the gaseous mixture while traversing via the locomotion means 104 in counter-current direction to the feed movement.

The desorption zone 110 desorbs the target gas from the sorbent material present inside each carriage.

Further, in each zone a sealing mechanism is applied to seal the inlet one-way valve and the outlet one-way valve of each carriage carrying the sorbent material during exit from at least one zone to prevent leakage with the adjoining zones.

In another embodiment, the plurality of zones comprises at least one of: (i) a cooling zone 112, or (ii) a maintenance zone 114, wherein the adsorption zone and the desorption zone are connected with the cooling zone and the maintenance zone in series of the closed loop.

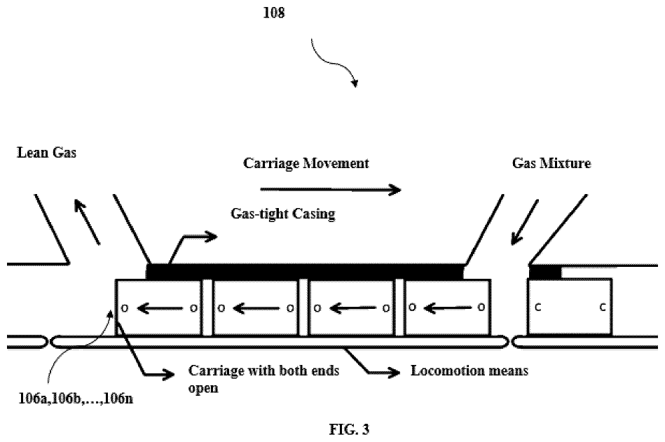

FIG. 3 illustrates a schematic view of an adsorption zone for gas separation process using the system of FIG. 1, in accordance with some embodiments of the present disclosure. Referring now FIG. 2 and FIG. 3 in the adsorption zone, the plurality of carriages (106a,106b, . . . ,106n) carrying the sorbent material traverses via the locomotion means 104 with minimal gap between two or more carriages. The inlet one-way valve and the outlet one-way valve of each carriage carrying the sorbent material remains open. Further at least one of the adsorption zone 108 receives the gaseous mixture from which the sorbent material present inside each carriage absorbs the target gas(es). The raffinate from the gaseous mixture is discharged through at least one outlet port of the adsorption zone 108.

The plurality of carriages (106a,106b, . . . ,106n) hosting the adsorbent material may have shutter like arrangements that can open and close located in the front end and the rear end to allow for entry and exit of gas flow. When both the ends are closed, it shall isolate the carriage from processing any gas, thus preventing gas leakage. The adsorption zone 108 consists of carriages moving in series, with no gaps between them moving in counter-current direction to the feed. Both the ends of each carriage in the adsorption zone are open to allow the gas to flow sequentially through the adsorbent bed in each carriage. As a saturated carriage exits the adsorption zone 108, both its ends are closed to seal the carriage and prevent any further entry of gas. The plurality of carriages (106a,106b, . . . ,106n) exiting the adsorption zone 108 speed up to increase the gap with the immediately trailing carriage so that it becomes the first entry point of the feed gas stream, and to quickly pass at least one inlet port so that continuity of the process is maintained.

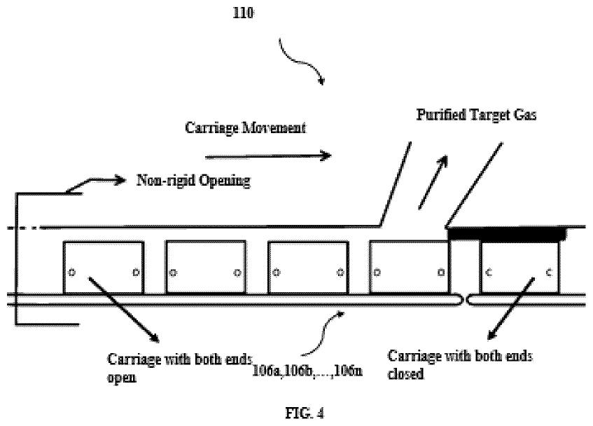

FIG. 4 illustrates a schematic view of a desorption zone for gas separation process using the system of FIG. 1, in accordance with some embodiments of the present disclosure.

In one embodiment, the modular true moving bed apparatus facilitates at least one of (i) a temperature swing adsorption, (ii) a pressure swing adsorption, (iii) a vacuum swing adsorption or (iv) a combination thereof. Here, the temperature swing adsorption allows desorption of the target gas by passing the hot gas which enters via the inlet port(s) and exits via the outlet port(s) of the desorption zone, moving against the direction of the carriage movement, the pressure swing adsorption allows desorption of the target gas by applying or maintaining lower pressure than used in the adsorption stage, and the vacuum swing adsorption allows desorption of the target gas by applying vacuum.

When each carriage reaches the desorption zone 108, both the inlet one-way valve and the outlet one-way valve are opened, and the gas is desorbed using at least one of the pressure swing adsorption, the vacuum swing adsorption and the temperature swing adsorption or the combination thereof. Heat is supplied directly since direct heating through mediums such as the steam or hot gases is more efficient. This would largely be driven by the type of adsorbent used. Additional equipment may be needed to separate the heating medium from the desorbed gas(es). Alternately, when the pressure swing adsorption or the vacuum swing adsorption is preferred, the pressure is lowered or maintaining sufficiently low pressure by suction fans should assist in regenerating the adsorbents. This would result in direct collection of the adsorbed gas(es). In some cases, concentration swing may be practiced using the eluent.

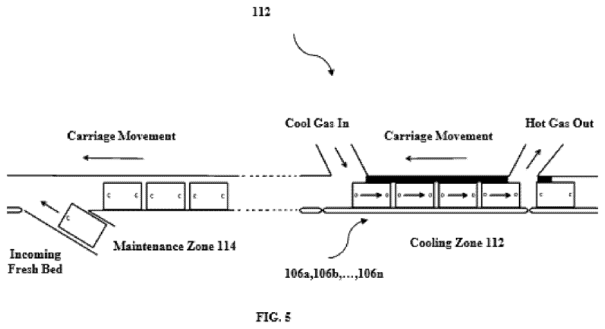

FIG. 5 illustrates a schematic view of a cooling zone and a maintenance zone for gas separation process using the system of FIG. 1, in accordance with some embodiments of the present disclosure. The desorption zone 110 is followed by the cooling zone 112, when necessary, in which the cooling gas flows in counter-current direction to cool the adsorbent bed getting it ready for the next cycle. The cooling zone 112 cools the sorbent material present inside each carriage using a cooling gas that enters via at least one inlet port and exits as warm gas via at least one outlet port, and the carriage have the front end one-way valve and the rear end one-way valve opened while moving in series via the locomotion means in counter-current direction. The maintenance zone 114 provides configuration aids for continuity of operations by replacing depleted carriages with new carriage using a sealing mechanism. This primarily removes the heat of adsorption that was released during the adsorption process and the heat supplied directly or indirectly during the desorption step.

Since the adsorption capacity may go down because of repeated use of the adsorbents over long period of time, the maintenance zone 114 provides configuration aids for continuity of operations by replacing depleted carriages with new carriage using a sealing mechanism. The maintenance zone 114 is used to replace carriages with reduced bed capacity with a fresh bed without disrupting the ongoing process by diverting the depleted carriages by using the sealing mechanism, for example, another track or a robotic arm. The plurality of carriages in the maintenance zone 114 finally move to the adsorption zone 108 for the next cycle.

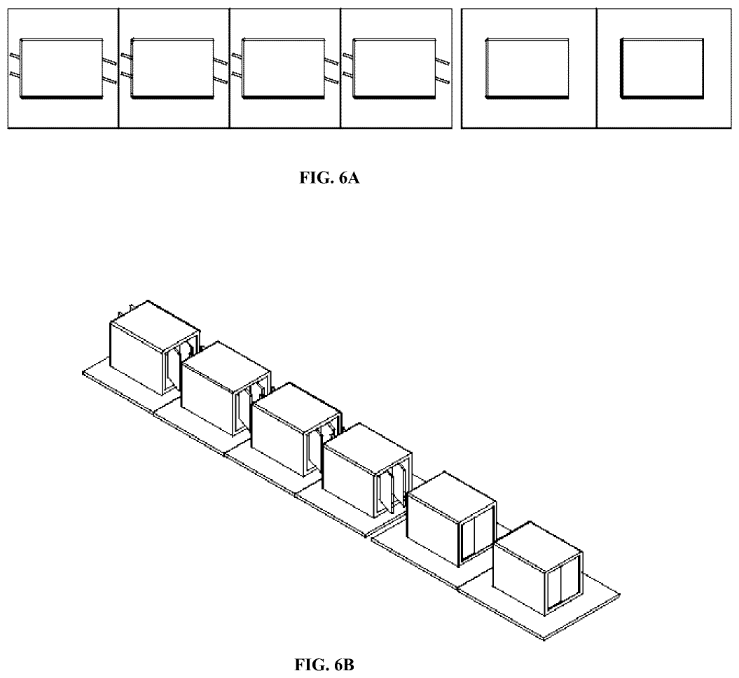

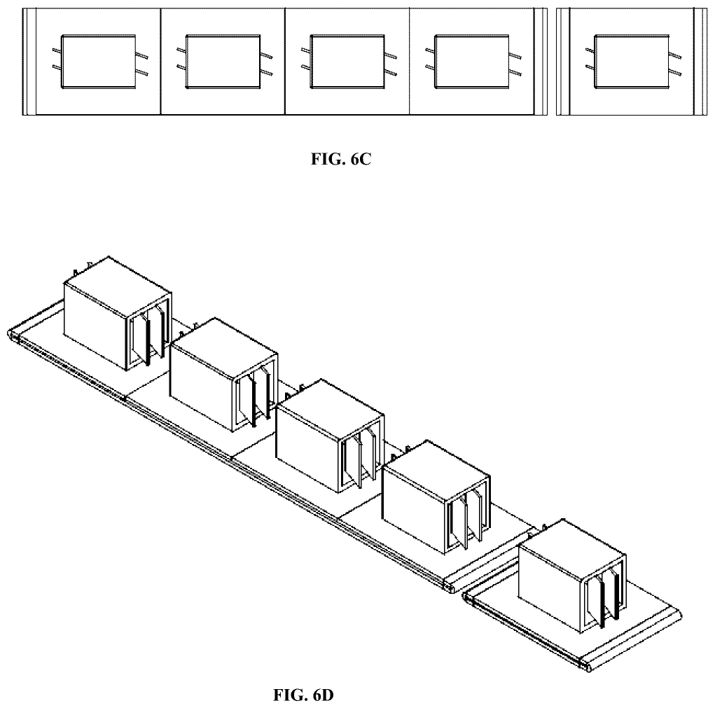

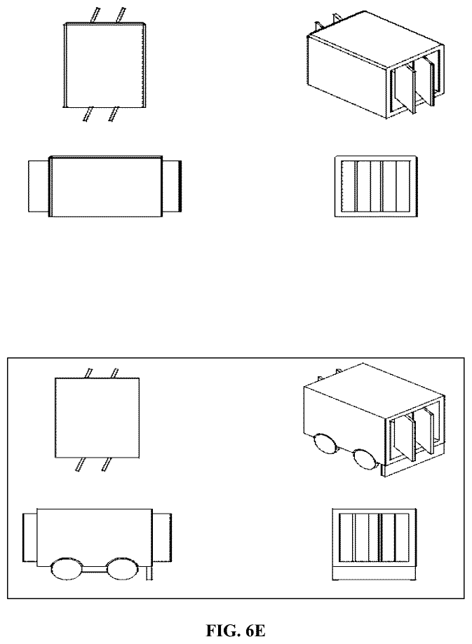

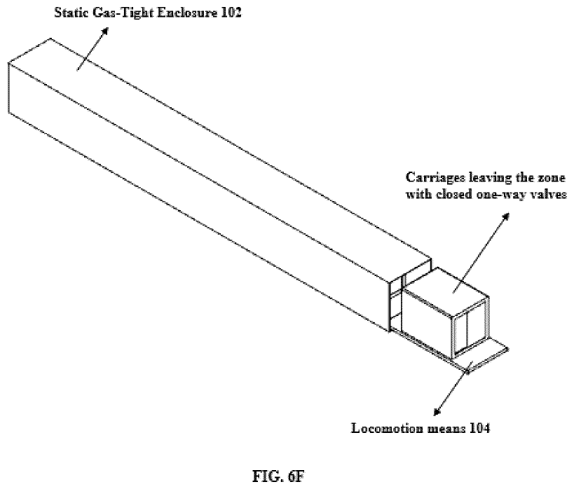

FIG. 6A and FIG. 6B illustrates a top view and an isometric view of a plurality of carriages inside the adsorption zone and exiting the adsorption zone, with the front end and rear end one-way valve opened while in the zone and closed while exiting the zone using the system of FIG. 1, in accordance with some embodiments of the present disclosure.

In the adsorption zone 108, the plurality of carriages (106a,106b, . . . ,106n) carrying the sorbent material traverse via the locomotion means 104. The front end and the rear end of each carriage are opened to allow for sequential passage of the gaseous mixture and to absorb the target gas from the gaseous mixture. As the saturated carriages exit, both the front end and the rear end are closed to seal each carriage thereby preventing any further entry of gas and leakage to the adjoining zone. Each carriage exiting the adsorption zone 108 speeds up to increase the gap with the immediately trailing carriage, quickly passing the adsorption inlet port(s) to maintain the continuity of the process.

FIG. 6C and FIG. 6D illustrates a top view and an isometric view of the plurality of carriages inside the desorption zone and exiting the desorption zone, with the front end and rear end one-way valve opened using the system of FIG. 1, in accordance with some embodiments of the present disclosure. In the desorption zone 110, the plurality of carriages (106a,106b, . . . ,106n) carrying the sorbent material traverse via the locomotion means 104. When the plurality of carriages (106a,106b, . . . ,106n) reach the desorption zone 110, the front end and the rear end of each carriage are opened to desorb the target gas from the gaseous mixture.

The target gas is desorbed using either pressure swing or vacuum swing or temperature swing adsorption or a combination thereof. Additional equipment may be required to separate the heating medium from the desorbed gas(es). Alternately, when the pressure swing adsorption or the vacuum swing adsorption is preferred, maintaining sufficiently low pressure by suction or draft fans assists in regenerating the adsorbents. This operation would result in the direct collection of the adsorbed gas(es).

It is noted, the gas separation process may not be limited in application of the pressure swing adsorption or the vacuum swing adsorption but can be extended to concentration swing with an eluent flow.

FIG. 6E illustrates the carriage design for carrying the sorbent material through the plurality of zones via locomotion means using the system of FIG. 1, in accordance with some embodiments of the present disclosure. The design of each carriage depends on the process requirements and process optimization. The cross-section of each carriage may be, but not limited to, circular. Such design depends upon the locomotion means 104 employed in the gas separation process. The track may consist of set of rollers or ball bearings which rotate to facilitate the movement of each carriage, or consist of the conveyor belt, in which case the bottom face of the carriages will be flat. In other example, each carriage itself may consist of wheels, which move on a flat track, hence facilitating independent locomotive control of each carriage.

FIG. 6F illustrates airtight casing around the apparatus with carriages moving on conveyor belt via locomotion means using the system of FIG. 1, in accordance with some embodiments of the present disclosure. The airtight casing around the apparatus prevents gas leakage to the surroundings. The airtight casing minimizes the gas bypass in different zone to minimum, therefore close tolerance between the locomotion means, carriages and casing is required.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein addresses unresolved problem of gas separation. The embodiment, thus provides modular true moving bed apparatus for gas separation and method of same. Moreover, the embodiments herein further provides an efficient solution addressing the particle attrition problem in modular true moving bed apparatus gas separation, preventing gas leakage across different zones.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A modular true moving bed apparatus for gas separation 100, comprising:
a static gas-tight enclosure 102;
a locomotion means 104;
a plurality of carriages (106a,106b, . . . , 106n) capable of traversing via the locomotion means 104, wherein each of the plurality of carriages comprises a front end having an inlet one-way valve, and a rear end having an outlet one-way valve, and each of the plurality of carriages carries a sorbent material, wherein the locomotion means 104 provides a mechanism to adjust a distance between two consecutive carriages from among the plurality of carriages while in motion; and
a plurality of zones comprising an adsorption zone 108 and a desorption zone 110, connected in series in a closed loop, wherein the plurality of carriages (106a,106b, . . . ,106n) traverse through the plurality of zones, and each of the plurality of zones comprises at least one inlet port to feed a gaseous mixture and at least one outlet port to exit raffinate,
wherein each of the plurality of carriages (106a,106b, . . . ,106n) carrying the sorbent material traverses via the locomotion means through each zone during the gas separation process,
wherein the adsorption zone 108 receives a gaseous mixture from at least one of the inlet port, and each of the plurality of carriages (106a,106b, . . . ,106n) carrying the sorbent material adsorbs a target gas from the gaseous mixture while traversing via the locomotion means 104,
wherein the desorption zone 110 desorbs the target gas from the sorbent material present inside each of the plurality of carriages (106a,106b, . . . , 106n), and
wherein a sealing mechanism seals the inlet one-way valve and the outlet one-way valve of each of the plurality of carriages carrying the sorbent material to prevent leakage in the adjoining zones.

2. The modular true moving bed apparatus for gas separation of claim 1, wherein the plurality of carriages and the gaseous mixture move in counter-current direction in at least one of the zone.

3. The modular true moving bed apparatus for gas separation of claim 1, wherein the plurality of carriages associated with the adsorption zone carrying the sorbent material traverses via the locomotion means with minimal gap between two or more carriages from among the plurality of carriages by,
opening the inlet one-way valve and the outlet one-way valve of each carriage carrying the sorbent material;
receiving via at least one inlet port of the adsorption zone the gaseous mixture, and the sorbent material present inside each carriage adsorbs the target gas from the gaseous mixture; and
discharging raffinate of the gaseous mixture through at least one outlet port of the adsorption zone.

4. The modular true moving bed apparatus for gas separation of claim 1, wherein in the desorption zone, the front end and the rear end of each carriage carrying the sorbent material is opened while traversing via the locomotion means, and the gap between two or more carriages is increased to desorb the target gas.

5. The modular true moving bed apparatus for gas separation of claim 1, wherein the sorbent material residing inside the plurality of carriages have no relative motion among themselves, resulting in minimal particle attrition.

6. The modular true moving bed apparatus for gas separation of claim 1, wherein the modular true moving bed apparatus facilitates at least one of (i) a temperature swing adsorption, (ii) a pressure swing adsorption, (iii) a vacuum swing adsorption or (iv) a combination thereof.

7. The modular true moving bed apparatus for gas separation of claim 6, wherein in the desorption zone, (i) the temperature swing adsorption allows desorption of the target gas by passing a hot gas, (ii) the pressure swing adsorption allows desorption of the target gas by applying low pressure, and (iii) the vacuum swing adsorption allows desorption of the target gas by applying vacuum.

8. The modular true moving bed apparatus for gas separation of claim 1, wherein the plurality of zones comprises at least one of: (i) a cooling zone 112, or (ii) a maintenance zone 114, wherein the adsorption zone and the desorption zone are connected with the cooling zone and the maintenance zone in series of the closed loop,
wherein the cooling zone cools the sorbent material present inside each carriage using a cooling gas that enters via at least one inlet port and exits as warm gas via at least one outlet port, and the carriage have the front end one-way valve and the rear end one-way valve opened while moving in series via the locomotion means in counter-current direction, and
wherein the maintenance zone provides configuration aids for continuity of operations by replacing depleted carriages with new carriage using a suitable mechanism.

9. A process of modular true moving bed for gas separation, comprising:
moving by a plurality of carriages carrying a sorbent material through a plurality of zones via a locomotion means to reach at least one of an adsorption zone, and a desorption zone;
feeding via at least one inlet port of the adsorption zone, a gaseous mixture over the plurality of carriages carrying the sorbent material;
adsorbing a target gas from the gaseous mixture by the sorbent material while passing through the adsorption zone when the plurality of carriages are traversing via the locomotion means in the adsorption zone;
desorbing the target gas from the sorbent material present inside each carriage in the desorption zone; and
sealing using a suitable sealing mechanism, the inlet one-way valve and the outlet one-way valve of each carriage carrying the sorbent material during exit from at least one zone to prevent leakage with the adjoining zones.

10. The process of modular true moving bed for gas separation of claim 9, wherein the plurality of carriages and the gaseous mixture move in counter-current direction in at least one of the zone.

11. The process of modular true moving bed for gas separation of claim 9, wherein the plurality of carriages associated with the adsorption zone carrying the sorbent material traverses via the locomotion means with minimal gap between two or more carriages from among the plurality of carriages by,
opening the inlet one-way valve and the outlet one-way valve of each carriage carrying the sorbent material;
receiving via at least one inlet port of the adsorption zone the gaseous mixture, and the sorbent material present inside each carriage adsorbs the target gas from the gaseous mixture; and
discharging raffinate of the gaseous mixture through at least one outlet port of the adsorption zone.

12. The process of modular true moving bed for gas separation of claim 9, wherein in the desorption zone, the front end and the rear end of each carriage carrying the sorbent material is opened while traversing via the locomotion means, and the gap between two or more carriages is increased to desorb the target gas.

13. The process of modular true moving bed for gas separation of claim 9, wherein the sorbent material residing inside the plurality of carriages have no relative motion among themselves, resulting in minimal particle attrition.

14. The process of modular true moving bed for gas separation of claim 9, wherein the modular true moving bed apparatus facilitates at least one of (i) a temperature swing adsorption, (ii) a pressure swing adsorption, (iii) a vacuum swing adsorption or (iv) a combination thereof.

15. The process of modular true moving bed for gas separation of claim 14, wherein in the desorption zone, (i) the temperature swing adsorption allows desorption of the target gas by passing a hot gas, (ii) the pressure swing adsorption allows desorption of the target gas by applying low pressure, and (iii) the vacuum swing adsorption allows desorption of the target gas by applying vacuum.

16. The process of modular true moving bed for gas separation of claim 9, wherein the plurality of zones comprises at least one of: (i) a cooling zone, or (ii) a maintenance zone, wherein the adsorption zone and the desorption zone are connected with the cooling zone and the maintenance zone in series of a closed loop,
wherein the cooling zone cools the sorbent material present inside each carriage using a cooling gas that enters via at least one inlet port and exits as warm gas via at least one outlet port, and the carriage have the front end one-way valve and the rear end one-way valve opened while moving in series via the locomotion means in counter-current direction, and
wherein the maintenance zone provides configuration aids for continuity of operations by replacing depleted carriages with new carriage using a suitable mechanism.
